(19) United States
(12) Patent Application Publication
(10) Pub. No.: US 2024/0199780 A1
(43) Pub. Date: Jun. 20, 2024

(54) FLUORINE-BASED POLYMER, FLUORINE-BASED POLYMER COMPOSITION COMPRISING SAME, AND FLUORINE-BASED POLYMER MEMBRANE USING SAME

(71) Applicant: KOREA RESEARCH INSTITUTE OF CHEMICAL TECHNOLOGY, Daejeon (KR)

(72) Inventors: Eun-Ho SOHN, Daejeon (KR); Won Wook SO, Daejeon (KR); In Joon PARK, Daejeon (KR); Bong Jun CHANG, Daejeon (KR); Ju Hyeon KIM, Daejeon (KR); Ji Hoon BAIK, Daejeon (KR); Myung Seok OH, Daejeon (KR); Jong Min KIM, Daejeon (KR); Sang Goo LEE, Daejeon (KR); Myoung Sook LEE, Daejeon (KR); Hyeon Jun HEO, Daejeon (KR); Shin Hong YOOK, Daejeon (KR)

(21) Appl. No.: 18/286,104

(22) PCT Filed: Feb. 7, 2022
(86) PCT No.: PCT/KR2022/001798

§ 371 Date: Oct. 6, 2023

(30) Foreign Application Priority Data
Apr. 9, 2021 (KR) 10-2021-0046339

(51) Int. Cl. C08F 220/22; C08F 220/06; C08F 220/18; C08F 220/20; C08K 5/29; C09D 5/16; C09D 133/16

(52) U.S. Cl. CPC C08F 220/22; C08F 220/06; C08F 220/1818; C08F 220/20; C08K 5/29; C09D 5/1668; C09D 133/16

(57) ABSTRACT

The objective of the present invention is to provide a fluorine-based polymer having a low surface energy, a fluorine-based polymer composition comprising same, a fluorine-based polymer membrane comprising same, and a method for manufacturing same. The present invention provides an acrylate-based copolymer, and in particular, the present invention is characterized in that the number of fluorocarbons in the repeating unit is limited to 3 to 5, such that the surface energy of the polymer and the polymer membrane produced therefrom is significantly lowered. In addition, when the polymer of the present invention is coated on glass, etc., the polymer has the effect of remarkably improving light transmittance, and has excellent mechanical strength.

### BACKGROUND OF THE INVENTION

### 1. Field of the Invention

The present invention relates to a fluorine-based polymer, a fluorine-based polymer composition comprising the same, and a fluorine-based polymer membrane using the same.

### 2. Description of the Related Art

Fluorine has a high electron density and the smallest atomic radius after the hydrogen atom, and it also has a strong electronegativity, so it forms a strong carbon-fluorine bond. Due to these fluorine-based characteristics, monomers containing perfluoroalkyl groups are extremely hydrophobic, with critical surface tension of 6-8 dynes/cm, and have very low surface energy, repelling both water and oil. Accordingly, fluorine-based compounds are gradually expanding their use due to their excellent chemical stability, heat resistance, weather resistance, non-adhesiveness, low surface energy, water repellency, and low refractive index, despite their relatively high price.

Currently, fluorine-based functional materials are widely used as core materials for next-generation technologies in the high-tech industries of optical communications, optoelectronics, semiconductors, automobiles, and computers because of their excellent performance in stain resistance, weather resistance, heat resistance, and optical properties that other materials cannot achieve. In particular, research on fluorine-based functional materials is being actively conducted due to the increasing interest in anti-fouling coatings, including anti-fouling coatings such as the front outermost layer of liquid crystal displays or the frame of aesthetic displays, which are rapidly increasing in recent years, as well as various paints and coating agents applied to household appliances, architecture, shipbuilding, and civil engineering fields that require traditional anti-fouling surface properties.

Fluoropolymers are materials having such properties as low surface energy, water repellency, lubricity, and low refractive index along with excellent heat resistance, chemical resistance, and weather resistance, and have been widely used throughout the industry, starting with household products.

However, despite their excellent performance (water repellency, stain resistance, etc.), conventional fluoropolymers have been facing significant manufacturing problems due to the high cost of materials and the difficulty of using general organic solvents.

Furthermore, since the surface energy of the conventional fluoropolymer or antifouling film containing the same is not sufficiently low, there is a need to further improve antifouling properties.

In addition, depending on the type of substrate, there have been problems such as poor adhesion when coating on the substrate. That is, if it is well soluble in general organic solvents while maintaining the performance of a fluoropolymer and has excellent adhesion to a substrate for use as a coating material, its industrial value is expected to be very great.

### SUMMARY OF THE INVENTION

It is an object of the present invention to provide a fluorine-based polymer having a low surface energy, a fluorine-based polymer composition comprising the same, a fluorine-based polymer membrane containing the same, and a manufacturing method thereof.

To achieve the above object, the present invention provides a fluorine-based polymer represented by the following formula 1:

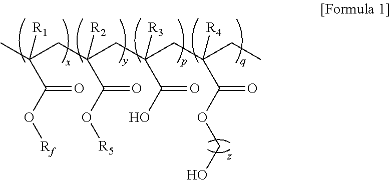

(In formula 1 above,
R_{f} is C₁₋₂₀ fluorinated straight alkyl or C₃₋₂₀ fluorinated branched alkyl, in which the number of fluorocarbon is 3 to 5; to be precise, R_{f} is the concatenation of CₙH₂ₙ and CₘF₂ₘ₊₁, where n is 1-3 and m is 3-5;
R₁₋₄ is independently hydrogen (H), methyl (CH₃) or halogen;
R₅ is C₁₋₂₀ straight alkyl or C₃₋₂₀ branched alkyl;
based on the molar ratio of x+y+p+q=100, x is 30 to 70, p is 5 to 20, and y+q is 20 to 60; and
z is 1-5.).

The present invention also provides a fluorine-based polymer composition comprising a fluorine-based polymer represented by formula 1 below and an organic solvent :

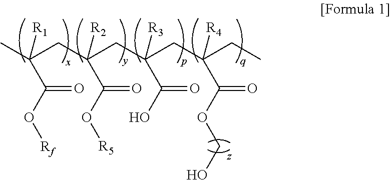

(In formula 1 above,
R_{f} is C₁₋₂₀ fluorinated straight alkyl or C₃₋₂₀ fluorinated branched alkyl, in which the number of fluorocarbon is 3 to 5;
R₁₋₄ is independently hydrogen (H), methyl (CH₃) or halogen;
R₅ is C₁₋₂₀ straight alkyl or C₃₋₂₀ branched alkyl;
based on the molar ratio of x+y+p+q=100, x is 30 to 70, p is 5 to 20, and y+q is 20 to 60; and
z is 1-5.).

In addition, the present invention provides a fluorine-based polymer membrane comprising a fluorine-based polymer represented by the following formula 1:

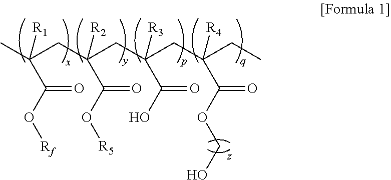

(In formula 1 above,
R_{f} is C₁₋₂₀ fluorinated straight alkyl or C₃₋₂₀ fluorinated branched alkyl, in which the number of fluorocarbon is 3 to 5;
R₁₋₄ is independently hydrogen (H), methyl (CH₃) or halogen;
R₅ is C₁₋₂₀ straight alkyl or C₃₋₂₀ branched alkyl;
based on the molar ratio of x+y+p+q=100, 5 x is 30 to 10, p is 5 to 20, and y+q is 20 to 60; and
z is 1-5.).

### Advantageous Effect

The fluorine-based polymer provided in one aspect of the present invention has low surface energy and high light transmittance, so it can be applied to various applications requiring these characteristics. At the same time, there is an effect of exhibiting excellent pencil strength.

In addition, the fluorine-based polymer provided in one aspect of the present invention can be applied as a surface coating and membrane material for various products due to its high solubility in general organic solvents despite having a very low surface energy during coating.

Furthermore, it has excellent adhesion to the substrate surface and can be cured, so it can be applied to various fields such as automotive glass, building exterior materials, condensers in freshwater or power plants, and solar cells.

### BRIEF DESCRIPTION OF THE DRAWINGS

FIG. 1 is a graph showing the curing process of a polymer membrane comprising a curing agent prepared according to one embodiment of the present invention,

FIG. 2 is a photograph showing the mechanical strength of a polymer prepared according to one embodiment of the present invention,

FIG. 3 is a photograph showing the boundary line of the mechanical strength of a polymer prepared according to one embodiment of the present invention, and

FIG. 4 is a transmittance graph confirming that a polymer membrane prepared according to one embodiment of the present invention improves light transmittance.

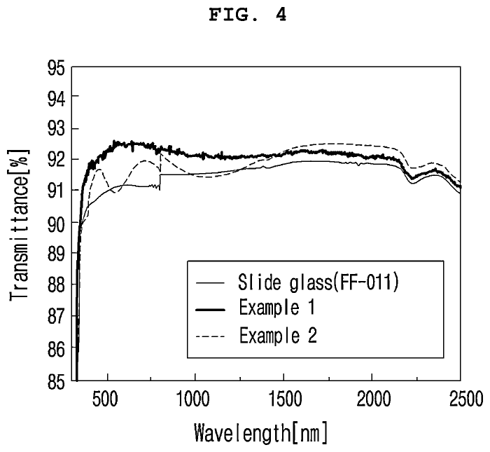

### DESCRIPTION OF THE PREFERRED EMBODIMENTS

In one aspect of the present invention, the invention provides a fluorine-based polymer represented by the following formula 1:

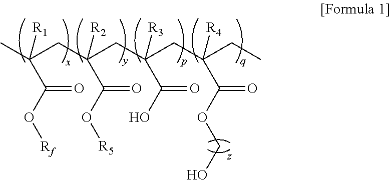

(In formula 1 above,
R_{f} is C₁₋₂₀ fluorinated straight alkyl or C₃₋₂₀ fluorinated branched alkyl, in which the number of fluorocarbon is 3 to 5; to be precise, R_{f} is the concatenation of CₙH₂ₙ and CₘF₂ₘ₊₁, where n is 1-3 and m is 3-5;
R₁₋₄ is independently hydrogen (H), methyl (CH₃) or halogen;
R₅ is C₁₋₂₀ straight alkyl or C₃₋₂₀ branched alkyl;
based on the molar ratio of x+y+p+q=100, x is 30 to 70, p is 5 to 20, and y+q is 20 to 60; and
z is 1-5.).

Hereinafter, a fluorine-based polymer according to the present invention is described in detail.

The fluorine-based polymer according to the present invention can be represented by formula 1 above.

In the fluorine-based polymer represented by formula 1 above, R_{f} is C₁₋₂₀ fluorinated straight alkyl or C₃₋₂₀ fluorinated branched alkyl, wherein the number of fluorocarbon is 3 to 5, and more preferably 4.

In addition, as an example, in the fluorine-based polymer represented by formula 1 above, R₁, R₂, R₃, and R₄ can be independently hydrogen (H), methyl (CH₃), and halogen, respectively. The halogen may be fluorine (F) or chlorine (Cl). Furthermore, in the fluorine-based polymer represented by formula 1 above, R₁ is preferably hydrogen, and R₂, R₃ and R₄ are methyl.

In addition, as an example, in the fluorine-based polymer represented by formula 1 above, R₅ can be represented by —(CH₂)_{c}—CH₃.

In this case, c may be an integer in the range of 0-15, an integer in the range of 1-10, an integer in the range of 1-5, but the range of the value of c is not limited thereto.

Further, in the fluorine-based polymer represented by formula 1 above, x, y, p, and q are such that, based on a molar ratio of x+y+p+q=100, x is 30 to 70, p is 5 to 20, and y+q is 20 to 60.

More preferably, x is 60, p is 10 to 15, and y+q is 20 to 30. By having a composition in the above range, the polymer can exhibit significantly higher pencil strength with lower surface energy and higher light transmittance.

In addition, as an example, the fluorine-based polymer represented by formula 1 above preferably has a number average molecular weight of 70,000 to 100,000. If the number average molecular weight of the fluorine-based polymer is less than 70,000, the thermal and mechanical strength of the polymer may decrease, and if it exceeds 100,000, the solubility in organic solvents may decrease rapidly.

Unlike conventional fluorine-based polymers, the polymer represented by formula 1 provided in one aspect of the present invention is soluble in generally known organic solvents, and thus has a very advantageous effect in the manufacturing process. Examples of the organic solvent include any general organic solvent, such as at least one selected from the group consisting of tetrahydrofuran (THF), 2-butanol (MEK), methylisobutyl ketone (MIBK), propylene glycol methyl ether (PGMEA), and the like. However, it is preferable to use a solvent capable of dissolving both the monomer before reaction and the polymer after reaction as the organic solvent at this time.

The present invention also provides a fluorine-based polymer composition comprising a fluorine-based polymer represented by formula 1 below and an organic solvent:

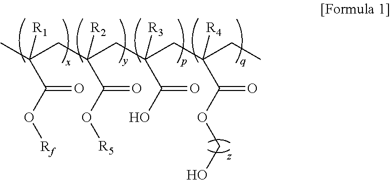

(In formula 1 above,
R_{f} is C₁₋₂₀ fluorinated straight alkyl or C₃₋₂₀ fluorinated branched alkyl, in which the number of fluorocarbon is 3 to 5;
R₁₋₄ is independently hydrogen (H), methyl (CH₃) or halogen;
R₅ is C₁₋₂₀ straight alkyl or C₃₋₂₀ branched alkyl;
based on the molar ratio of x+y+p+q=100, x is 30 to 70, p is 5 to 20, and y+q is 20 to 60; and
z is 1-5.).

Hereinafter, a fluorine-based polymer composition according to the present invention is described in detail.

The fluorine-based polymer is as described above. The fluorine-based polymer according to the present invention has low surface energy and high light transmittance, so it can be applied to various applications requiring these characteristics. The fluorine-based polymer composition is a composition for such applications, characterized in that it has a high solubility in organic solvents.

The organic solvent can be at least one selected from the group consisting of tetrahydrofuran (THF), 2-butanol (MEK), methylisobutyl ketone (MIBK), propylene glycol methyl ether (PGMEA), and the like, but not always limited thereto. However, it is preferable to use a solvent capable of dissolving both the monomer before reaction and the polymer after reaction.

Preferably, the fluorine-based polymer composition further includes a curing agent comprising an isocyanate group. The synthesized fluorine-based polymer can have stronger chemical and mechanical durability by including a curing agent. However, when the curing agent reacts with the polymer at room temperature, the viscosity changes over time from the moment of mixing, resulting in poor workability and storability. To prevent this, it is desirable to use a curing agent composed of a compound in which reactive groups dissociate at a certain temperature, and in view of this, it is desirable to further include an HDI trimer-based curing agent containing an isocyanate group.

If the fluorine-based polymer composition of the present invention further includes a curing agent comprising an isocyanate group, the curing agent is preferably included in a molar ratio of 1.1 to 1.5 based on the total number of moles of a hydroxyl group in the fluorine-based polymer. If the amount is less than 1.1, the degree of curing is reduced and the mechanical and chemical properties are not sufficient, and if the amount exceeds 1.5, the content ratio of fluorine methacrylate to the total composition is reduced and the surface energy is increased.

The fluorine-based polymer composition provided in one aspect of the present invention exhibits very low surface energy and excellent light transmittance. In addition, it has excellent adhesion to the substrate surface and can be cured, so it can be applied to various fields such as automotive glass, building exterior materials, condensers in freshwater or power plants, and solar cells.

The present invention also provides a fluorine-based polymer membrane comprising a fluorine-based polymer represented by the following formula 1:

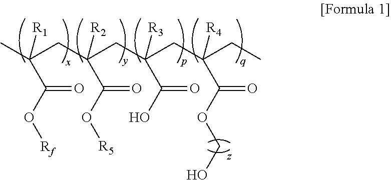

(In formula 1 above,
R_{f} is C₁₋₂₀ fluorinated straight alkyl or C₃₋₂₀ fluorinated branched alkyl, in which the number of fluorocarbon is 3 to 5;
R₁₋₄ is independently hydrogen (H), methyl (CH₃) or halogen;
R₅ is C₁₋₂₀ straight alkyl or C₃₋₂₀ branched alkyl;
based on the molar ratio of x+y+p+q=100, x is 30 to 70, p is 5 to 20, and y+q is 20 to 60; and
z is 1-5.).

Hereinafter, a fluorine-based polymer membrane according to the present invention is described in detail.

The fluorine-based polymer is as described above. The fluorine-based polymer according to the present invention has low surface energy and high light transmittance, so it can be applied to various applications requiring these characteristics. The fluorine-based polymer composition is a composition for such applications, characterized in that it has a high solubility in organic solvents.

Preferably, the fluorine-based polymer membrane further includes a curing agent comprising an isocyanate group. The synthesized fluorine-based polymer can have stronger chemical and mechanical durability by including a curing agent. However, when the curing agent reacts with the polymer at room temperature, the viscosity changes over time from the moment of mixing, resulting in poor workability and storability. To prevent this, it is desirable to use a curing agent composed of a compound in which reactive groups dissociate at a certain temperature, and in view of this, it is desirable to further include an HDI trimer-based curing agent containing an isocyanate group.

If the fluorine-based polymer membrane of the present invention further includes a curing agent comprising an isocyanate group, the curing agent is preferably included in a molar ratio of 1.1 to 1.5 based on the total number of moles of a hydroxyl group in the fluorine-based polymer. If the amount is less than 1.1, the degree of curing is reduced and the mechanical and chemical properties are not sufficient, and if the amount exceeds 1.5, the content ratio of fluorine methacrylate to the total composition is reduced and the surface energy is increased.

The fluorine-based polymer membrane provided in one aspect of the present invention exhibits very low surface energy and excellent light transmittance. In addition, it has excellent adhesion to the substrate surface and can be cured, so it can be applied to various fields such as automotive glass, building exterior materials, condensers in freshwater or power plants, and solar cells.

In another aspect of the present invention, method of producing a fluorine-based polymer membrane comprising the following steps is provided:
a step of preparing a polymer solution by dissolving the above fluorine-based polymer in an organic solvent (step 1); and
a step of applying the polymer solution of step 1 above to a substrate and drying it to form a polymer membrane (step 2).

Hereinafter, a method of producing a fluorine-based polymer membrane according to the present invention is described in detail.

First, in the method of producing a fluorine-based polymer membrane according to the present invention, step 1 is to prepare a polymer solution by dissolving the fluorine-based polymer presented in the present invention in an organic solvent.

The fluorine-based polymer according to the present invention has excellent solubility in organic solvents, so that a polymer solution can be easily prepared by dissolving it in an organic solvent.

For example, at least one selected from the group consisting of tetrahydrofuran (THF), 2-butanol (MEK), methylisobutyl ketone (MIBK), and propylene glycol methyl ether (PGMEA) can be used as the organic solvent in step 1, but not always limited thereto.

Next, in the method of producing a fluorine-based polymer membrane according to the present invention, step 2 is to apply the polymer solution of step 1 on a substrate and dry it to form a polymer membrane.

As a specific example, the application of step 2 can be performed by a method such as spin coating, dip coating, roll coating, or spray coating.

Meanwhile, the method of producing a fluorine-based polymer membrane preferably further includes a step of mixing a curing agent comprising an isocyanate group with the polymer solution prepared in step 1.

If a curing agent is further included in the process of producing a fluorine-based polymer membrane, it may have stronger chemical and mechanical durability. However, when the curing agent reacts with the polymer at room temperature, the viscosity changes over time from the moment of mixing, resulting in poor workability and storability. To prevent this, it is desirable to use a curing agent composed of a compound in which reactive groups dissociate at a certain temperature, and in view of this, it is desirable to further include an HDI trimer-based curing agent containing an isocyanate group.

If the method of producing a fluorine-based polymer membrane of the present invention further includes a step of mixing a curing agent comprising an isocyanate group, the curing agent is preferably included in a molar ratio of 1.1 to 1.5 based on the total number of moles of a hydroxyl group in the fluorine-based polymer. If the amount is less than 1.1, the degree of curing is reduced and the mechanical and chemical properties are not sufficient, and if the amount exceeds 1.5, the content ratio of fluorine methacrylate to the total composition is reduced and the surface energy is increased.

In another aspect of the present invention, a method of forming an antifouling coating film comprising the following steps is provided:
a step of preparing a polymer solution by dissolving the above fluorine-based polymer in an organic solvent (step 1); and
a step of applying the polymer solution of step 1 above to a substrate and drying it to form a polymer membrane (step 2).

Hereinafter, a method of producing an antifouling coating film according to the present invention is described in detail.

First, in the method of producing an antifouling coating film according to the present invention, step 1 is to prepare a polymer solution by dissolving the fluorine-based polymer presented in the present invention in an organic solvent.

The fluorine-based polymer according to the present invention has excellent solubility in organic solvents, so that a polymer solution can be easily prepared by dissolving it in an organic solvent.

For example, at least one selected from the group consisting of tetrahydrofuran (THF), 2-butanol (MEK), methylisobutyl ketone (MIBK), and propylene glycol (PGMEA) can be used as the organic methyl ether solvent in step 1, but not always limited thereto.

Next, in the method of producing an antifouling coating film according to the present invention, step 2 is to apply the polymer solution of step 1 on a substrate and dry it to form a polymer membrane.

As a specific example, the application of step 2 can be performed by a method such as spin coating, dip coating, roll coating, or spray coating.

Meanwhile, the method of producing an antifouling coating film preferably further includes a step of mixing a curing agent comprising an isocyanate group with the polymer solution prepared in step 1.

If a curing agent is further included in the process of producing an antifouling coating film, it may have stronger chemical and mechanical durability. However, when the curing agent reacts with the polymer at room temperature, the viscosity changes over time from the of moment mixing, resulting in poor workability and storability. To prevent this, it is desirable to use a curing agent composed of a compound in which reactive groups dissociate at a certain temperature, and in view of this, it is desirable to further include an HDI trimer-based curing agent containing an isocyanate group.

If the method of producing an antifouling coating film of the present invention further includes a step of mixing a curing agent comprising an isocyanate group, the curing agent is preferably included in a molar ratio of 1.1 to 1.5 based on the total number of moles of a hydroxyl group in the fluorine-based polymer. If the amount is less than 1.1, the degree of curing is reduced and the mechanical and chemical properties are not sufficient, and if the amount exceeds 1.5, the content ratio of fluorine methacrylate to the total composition is reduced and the surface energy is increased.

Hereinafter, the present invention will be described in detail by the following examples and experimental examples.

However, the following examples and experimental examples are only for illustrating the present invention, and the contents of the present invention are not limited thereto.

### Example 1: Preparation of Fluorine-Based Polymer

Copolymerization was performed by adding 60 mol % of NFHA (nonafluorohexyl acrylate), 10 mol % of SMA (stearyl methacrylate), 25 mol % of HEMA (hydroxyethyl methacrylate), and 5 mol % of MAA (methacrylic acid) based on the total copolymer. The above monomers were dissolved in tetrahydrofuran (THF) and warmed up to 60° C. under nitrogen atmosphere. Then, an AIBN (azobisisobutyro nitrile) initiator was added and reacted for about 8 hours. Thereafter, reflux was performed by raising the temperature to 80° C. to remove residual radicals, and then the reaction was terminated while cooling to room temperature to prepare a fluorine-based copolymer, that is, a fluorine-based polymer.

### Example 2: Preparation of Fluorine-Based Polymer

Copolymerization was performed by adding 60 mol % NFHA (nonafluorohexyl acrylate), 10 mol % of SMA (stearyl methacrylate), 20 mol % of HEMA (hydroxyethyl methacrylate), and 10 mol % of MAA (methacrylic acid) based on the total copolymer. The above monomers were dissolved in tetrahydrofuran (THF) and warmed up to 60° C. under nitrogen atmosphere. Then, an AIBN (azobisisobutyro nitrile) initiator was added and reacted for about 8 hours. Thereafter, reflux was performed by raising the temperature to 80° C. to remove residual radicals, and then the reaction was terminated while cooling to room temperature to prepare a fluorine-based copolymer, that is, a fluorine-based polymer.

### Example 3: Preparation of Fluorine-Based Polymer

Copolymerization was performed by adding 60 mol % NFHA (nonafluorohexyl acrylate), 10 mol % of SMA 4 (stearyl methacrylate), 15 mol % of HEMA (hydroxyethyl methacrylate), and 15 mol % of MAA (methacrylic acid) based on the total copolymer. The above monomers were dissolved in tetrahydrofuran (THE) and warmed up to 60° C. under nitrogen atmosphere. Then, an AIBN (azobisisobutyro nitrile) initiator was added and reacted for about 8 hours. Thereafter, reflux was performed by raising the temperature to 80° C. to remove residual radicals, and then the reaction was terminated while cooling to room temperature to prepare a fluorine-based copolymer, that is, a fluorine-based polymer.

### Example 4: Preparation of Fluorine-Based Polymer

Copolymerization was performed by adding 60 mol % of NFHA (nonafluorohexyl acrylate), 10 mol % of SMA (stearyl methacrylate), 10 mol % of HEMA (hydroxyethyl methacrylate), and 20 mol % of MAA (methacrylic acid) based on the total copolymer. The above monomers were dissolved in tetrahydrofuran (THF) and warmed up to 60° C. under nitrogen atmosphere. Then, an AIBN (azobisisobutyro nitrile) initiator was added and reacted for about 8 hours. Thereafter, reflux was performed by raising the temperature to 80° C. to remove residual radicals, and then the reaction was terminated while cooling to room temperature to prepare a fluorine-based copolymer, that is, a fluorine-based polymer.

### Example 5: Preparation of Fluorine-Based Polymer

Copolymerization was performed by adding 60 mol % of NFHA (nonafluorohexyl acrylate), 10 mol % of SMA (stearyl methacrylate), 20 mol % of MMA (methyl methacrylate), and 10 mol % of MAA (methacrylic acid) based on the total copolymer. The above monomers were dissolved in tetrahydrofuran (THF) and warmed up to 60° C. under nitrogen atmosphere. Then, an AIBN (azobisisobutyro nitrile) initiator was added and reacted for about 8 hours. Thereafter, reflux was performed by raising the temperature to 80° C. to remove residual radicals, and then the reaction was terminated while cooling to room temperature to prepare a fluorine-based copolymer, that is, a fluorine-based polymer.

### Example 6: Preparation of Fluorine-Based Polymer Membrane Containing Curing Agent

Copolymerization was performed by adding 60 mol % of NFHA (nonafluorohexyl acrylate), 10 mol % of SMA (stearyl methacrylate), 20 mol % of HEMA (hydroxyethyl methacrylate), and 10 mol % of MAA (methacrylic acid) based on the total copolymer. The above monomers were dissolved in tetrahydrofuran (THE) and warmed up to 60° C. under nitrogen atmosphere. Then, an AIBN (azobisisobutyro nitrile) initiator was added and reacted for about 8 hours. Thereafter, reflux was performed by raising the temperature to 80° C. to remove residual radicals, and then the reaction was terminated while cooling to room temperature to prepare a fluorine-based copolymer, that is, a fluorine-based polymer.

A polymer solution was prepared by dissolving the prepared fluorine-based polymer in a mixed solvent in which EK and PGMEA are mixed in a volume ratio of 9:1, and an HDI-based curing agent was introduced into the polymer solution in an amount such that the ratio of hydroxyl groups in the polymer to functional groups in the curing agent was 100:130 to prepare a polymer composition.

A fluorine-based polymer film was prepared by forming a membrane by spin-coating or bar-coating the polymer composition on a flat substrate, and then curing it by heating in an oven for 5 hours above 145° C., the dissociation temperature of the curing agent .

### Comparative Example 1: Preparation of Fluorine-Based Polymer

Copolymerization was performed by adding 60 mol % of NFHA (nonafluorohexyl acrylate), 10 mol % of SMA (stearyl methacrylate), and 30 mol % of HEMA (hydroxyethyl methacrylate) based on the total copolymer. The above monomers were dissolved in tetrahydrofuran (THF) and warmed up to 60° C. under nitrogen atmosphere. Then, an AIBN (azobisisobutyro nitrile) initiator was added and reacted for about 8 hours. Thereafter, reflux was performed by raising the temperature to 80° C. to remove residual radicals, and then the reaction was terminated while cooling to room temperature to prepare a fluorine-based copolymer, that is, a fluorine-based polymer.

### Comparative Example 2: Preparation of Fluorine-Based Polymer

Copolymerization was performed by adding 60 mol % of TDFOA (tridecafluoro n-octyl acrylate), 10 mol % of SMA (stearyl methacrylate), 20 mol % of HEMA (hydroxyethyl methacrylate), and 10 mol % of MAA (methacrylic acid) based on the total copolymer. The above monomers were dissolved in tetrahydrofuran (THF) and warmed up to 60° C. under nitrogen atmosphere. Then, an AIBN (azobisisobutyro nitrile) initiator was added and reacted for about 8 hours. Thereafter, reflux was performed by raising the temperature to 80° C. to remove residual radicals, and then the reaction was terminated while cooling to room temperature to is, a prepare a fluorine-based copolymer, that fluorine-based polymer.

### Comparative Example 3: Preparation of Fluorine-Based Polymer

Copolymerization was performed by adding 46 mol % of PFPMA (pentafluoropropyl methacrylate), 12 mol % of SMA (stearyl methacrylate), 20 mol % of MMA (methyl methacrylate), 23 of mol % HEMA (hydroxyethyl methacrylate), and 12 mol % of MAA (methacrylic acid) based on the total copolymer. The above monomers were dissolved in a solvent and warmed up to 60° C. under nitrogen atmosphere. Then, an AIBN (azobisisobutyro nitrile) initiator was added and reacted for about 8 hours. Thereafter, reflux was performed by raising the temperature to 80° C.to remove residual radicals, and then the reaction was terminated while cooling to room temperature to prepare a fluorine-based copolymer, that is, a fluorine-based polymer. A polymer solution composition was prepared by dissolving the prepared fluorine-based polymer in a mixed solvent of MEK/PGMEA and adding a curing agent.

### Experimental Example 1: Confirmation of Molecular Weight Distribution of Synthesized Polymer

Molecular weight (Mw) and polydispersity index (PDI) were measured through GPC (Gel Permeation Chromatography) measurement. THF was used for the measurement as a solvent. In the case of the polymer presented in the present invention (Example 2), the molecular weight was 85000 g/mol, and the PDI was 2.24. If the molecular weight of the polymer is too low, mechanical properties or surface properties may be deteriorated, and if the molecular weight is too high, it becomes difficult to dissolve in general-purpose solvents. For utilization as a highly versatile coating material considered in the present invention, the molecular weight is preferably between 70,000 and 100, 000. In addition, the PDI is a criterion representing the width of molecular weight distribution. If it is 2.5 or more in a structure such as the polymer copolymer of the present invention, it may affect the realization of uniform and constant physical properties. Therefore, it is desirable to optimize the synthesis conditions and process to have a PDI of less than that.

### Experimental Example 2: Thermogravimetric Analysis

Thermogravimetric analysis (TGA) measures the temperature at which pyrolysis occurs while heating a sample. The measurement is performed by raising the temperature of the sample to 100° C., returning it to room temperature, and then heating it to 600° C. at 10° C./min. In the case of the polymer presented in the present invention (Example 2), a mass loss of 1% was observed at 249° C., and a mass loss of 5% was observed at 300° C. The 1% mass loss temperature is a widely used indicator to determine when a material begins to pyrolyze, with higher values indicating that the material can be used in high temperature conditions. The 1% mass loss temperature of the polymer of Example 2 is higher than that of methacrylic copolymers, which are often below 200° C., indicating that it can be utilized at higher temperatures (>200° C.) than conventional methacrylic coating materials.

### Experimental Example 3

To confirm the curing process of the method of producing a polymer membrane including a curing agent according to the present invention, the following experiment was performed.

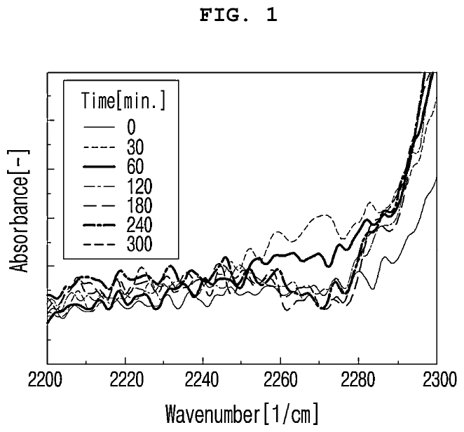

In the process of preparing a polymer membrane in Example 6, a polymer composition including a curing agent was heated to 145° C., and an isocyanate peak (2275 cm⁻¹) of the curing agent was confirmed through FT-IR (JASCO FT-IR 4100) measurement. The results are shown in FIG. 1. According to FIG. 1, it was confirmed that the peak increased as the block of the curing agent dissociated, and the peak decreased due to the urethane reaction between the hydroxyl group and the dissociated isocyanate group of the polymer. It was also confirmed that the reaction was almost completed after about 3 to 4 hours.

### Experimental Example 4

In order to confirm the surface energy of the polymer synthesized according to the present invention, the following experiment was performed.

A solution in which the PMMA polymer, the polymer according to Example 2 or Example 6, or the polymer according to Comparative Example 2 of the present invention was diluted to 4 weight % was spin-coated on a silicon wafer at 2000 rpm. The contact angles of water and diiodomethane (DIM) on the surface of the coated film were measured, and the surface energy was calculated by the OWRK method (Owens-Wendt-Rabel-Kaelble Method), and the results are shown in Table 1 below.

TABLE 1

| | | Water | DIM | Surface |
|---|---|---|---|---|
| | Number of | contact | contact | energy |
| | fluorocarbons | angle (°) | angle (°) | (mN/m) |
| PMMA | 0 | 75.6 | 35.1 | 43.7 |
| Example 2 | 4 | 127.1 | 112.4 | 4.94 |
| Example 6 | 4 | 122.6 | 104.9 | 7.1 |
| Comparative | 6 | 126.7 | 105.3 | 6.9 |
| Example 2 | | | | |

According to Table 1, it was confirmed that the polymer according to the present invention had a significantly lower surface energy than PMMA not containing fluorocarbons, and also had a lower surface energy than the polymer of Comparative Example 2 having a higher number of fluorocarbons than the polymer of the present invention. It was also confirmed that the polymer containing a curing agent (Example 6) still showed a low surface energy value. This value was lower than the surface energy of pure poly nonafluorohexyl acrylate (8.5 mN/m) measured by Honda et al. (Macromolecules 2010, 40, 454-460).

### Experimental Example 5

In order to confirm the changes in surface energy according to the adjustment of the monomers introduced as repeating units of the copolymer, the following experiment was performed.

A solution in which the polymer synthesized in Examples 1 to 5 or Comparative Example 1 of the present invention was diluted to 4 weights was spin-coated on a silicon wafer at 2000 rpm. The contact angles of water and diiodomethane (DIM) on the surface of the coated film were measured, and the surface energy was calculated by the OWRK method (Owens-Wendt-Rabel-Kaelble Method), and the results are shown in Table 2 below.

TABLE 2

| | | | | | | Contact | | Surface |
|---|---|---|---|---|---|---|---|---|
| | Monomer input ratio [mol %] | | | | | angle [°] | | energy |
| Sample | NFHA | MMA | SMA | MAA | HEMA | Water | DIM | [mN/m] |
| Comparative | 60 | 0 | 10 | 0 | 30 | 109.6 | 85.9 | 14.7 |
| Example 1 | | | | | | | | |
| Example 1 | 60 | 0 | 10 | 5 | 25 | 120.1 | 94.0 | 11.0 |
| Example 2 | 60 | 0 | 10 | 10 | 20 | 127.1 | 112.4 | 4.9 |
| Example 3 | 60 | 0 | 10 | 15 | 15 | 121.7 | 104.6 | 7.2 |
| Example 4 | 60 | 0 | 10 | 20 | 10 | 115.9 | 103.0 | 8.2 |
| Example 5 | 60 | 20 | 10 | 10 | 0 | 124.4 | 108.8 | 5.9 |

According to Table 2 above, the surface energy values of the polymers according to the present invention were all below 11.0 mN/m, and the lowest case was 4.9 mN/m, but in the case of Comparative Example 1, even if the composition was similar, it was confirmed that the surface energy increased rapidly when the composition was outside the scope of the present invention. In addition, as shown in Table 2, since the surface energy of the polymer according to Example 2 is remarkably low among the examples of the present invention, it is expected to show very excellent properties when applied to an antifouling film or the like.

### Experimental Example 6

To confirm the mechanical strength of the polymer according to the present invention, the following experiment was performed.

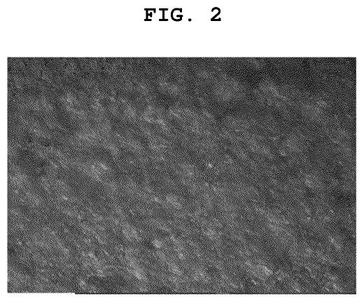

A film was prepared by bar-coding a solution containing 20 weight % of the polymer of Example 6 of the present invention to a height of 0.5 mm, and the hardness at which the film was damaged was measured by increasing pencil hardness from 2H with an applied load of 1 kg. The results are shown in FIG. 2.

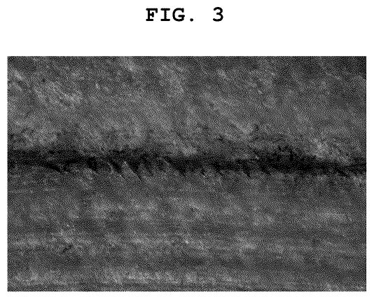

According to FIG. 3, no film damage was observed up to 5H of pencil hardness, but it was observed that the film was scratched and peeled off at 6H. Through this, it was confirmed that the mechanical durability of the coating prepared according to the present invention was between 5H and 6H.

### Experimental Example 7

To confirm the optical properties, that is, light transmittance, of the polymer membrane according to the present invention, the following experiment was performed.

A slide glass (Matsunami FF-011) showing high light transmittance was cleaned, and a coating solution in which the polymer of Example 2 or Comparative Example 3 of the present invention was mixed at 4 weight % based on the total solution was spin-coated on the slide glass at 2000 rpm, respectively, and UV-vis transmittance was measured (Cary 5000). The results are shown in FIG. 3.

It is known that fluoropolymers have excellent light transmittance as a unique property. According to FIG. 3, when the slide glass was coated with the solution of the present invention, it was confirmed that the light transmittance was remarkably improved, such as showing a transmittance of 92.55% at a wavelength of 580 nm.

What is claimed is:

1. A fluorine-based polymer represented by formula 1 below: 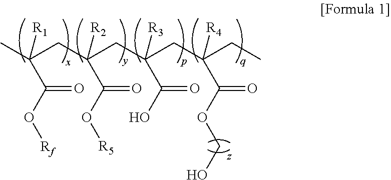
(In formula 1 above,
R_{f} is C₁₋₂₀ fluorinated straight alkyl or C₃₋₂₀ fluorinated branched alkyl, in which the number of fluorocarbon is 3 to 5;
R₁₋₄ is independently hydrogen (H), methyl (CH₃) or halogen;
R₅ is C₁₋₂₀ straight alkyl or C₃₋₂₀ branched alkyl;
based on the molar ratio of x+y+p+q=100, x is 30 to 70, p is 5 to 20, and y+q is 20 to 60; and
z is 1-5.).

2. The fluorine-based polymer according to claim 1, wherein the fluorine-based polymer has a number average molecular weight of 70,000 to 100,000.

3. The fluorine-based polymer according to claim 1, wherein the fluorine-based polymer is soluble in an organic solvent.

4. A fluorine-based polymer composition comprising a fluorine-based polymer represented by formula 1 below and an organic solvent: 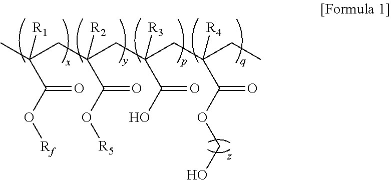
(In formula 1 above,
R_{f} is C₁₋₂₀ fluorinated straight alkyl or C₃₋₂₀ fluorinated branched alkyl, in which the number of fluorocarbon is 3 to 5;
R₁₋₄ is independently hydrogen (H), methyl (CH₃) or halogen;
R₅ is C₁₋₂₀ straight alkyl or C₃₋₂₀ branched alkyl;
based on the molar ratio of x+y+p+q=100, x is 30 to 70, p is 5 to 20, and y+q is 20 to 60; and
z is 1-5.).

5. The fluorine-based polymer composition according to claim 4, wherein the organic solvent is at least one selected from the group consisting of tetrahydrofuran (THF), 2-butanol (MEK), methylisobutyl ketone (MIBK), and propylene glycol methyl ether (PGMEA).

6. The fluorine-based polymer composition according to claim 4, wherein the fluorine-based polymer composition further includes a curing agent comprising an isocyanate group.

7. The fluorine-based polymer composition according to claim 6, wherein the curing agent comprising an isocyanate group is included in a molar ratio of 1.1 to 1.5 based on the total number of moles of a hydroxyl group in the fluorine-based polymer.

8. A fluorine-based polymer membrane comprising a fluorine-based polymer represented by formula 1 below: 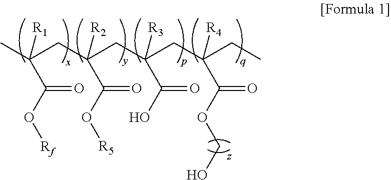
(In formula 1 above,
R_{f} is C₁₋₂₀ fluorinated straight alkyl or C₃₋₂₀ fluorinated branched alkyl, in which the number of fluorocarbon is 3 to 5;
R₁₋₄ is independently hydrogen (H), methyl (CH₃) or halogen;
R₅ is C₁₋₂₀ straight alkyl or C₃₋₂₀ branched alkyl;
based on the molar ratio of x+y+p+q=100, x is 30 to 70, p is 5 to 20, and y+q is 20 to 60; and
z is 1-5.).

9. The fluorine-based polymer membrane according to claim 8, wherein the fluorine-based polymer membrane further includes a curing agent comprising an isocyanate group.

10. The fluorine-based polymer membrane according to claim 9, wherein the curing agent comprising an isocyanate group is included in a molar ratio of 1.1 to 1.5 based on the total number of moles of a hydroxyl group in the fluorine-based polymer.

11. A method of producing a fluorine-based polymer membrane comprising the following steps:
a step of preparing a polymer solution by dissolving the fluorine-based polymer of claim 1 in an organic solvent (step 1); and
a step of applying the polymer solution of step 1 above to a substrate and drying it to form a polymer membrane (step 2).

12. The method of producing fluorine-based polymer membrane according to claim 11, wherein the method further includes a step of mixing a curing agent comprising an isocyanate group with the polymer solution prepared in step 1.

13. The method of producing a fluorine-based polymer membrane according to claim 12, wherein the curing agent is included in a molar ratio of 1.1 to 1.5 based on the total number of moles of a hydroxyl group in the fluorine-based polymer.

14. A method of forming an antifouling coating film comprising the following steps:
a step of preparing a polymer solution by dissolving the fluorine-based polymer of claim 1 in an organic solvent (step 1); and
a step of applying the polymer solution of step 1 above to a substrate and drying it to form a polymer membrane (step 2).

15. The method of forming an antifouling coating film according to claim 14, wherein the method further includes a step of mixing a curing agent comprising an isocyanate group with the polymer solution prepared in step 1.

16. The method of forming an antifouling coating film according to claim 14, wherein the curing agent is included in a molar ratio of 1.1 to 1.5 based on the total number of moles of a hydroxyl group in the fluorine-based polymer.
